(19) United States
(12) Patent Application Publication
(10) Pub. No.: US 2012/0058315 A1
(43) Pub. Date: Mar. 8, 2012

(54) METHOD FOR PRODUCING A TEXTILE COMPLEX INCLUDING DECORATIVE PATTERNS, AND COMPLEX THUS PRODUCED

(75) Inventors: Sylvain Antheme, Le Cheylard (FR); Stephane Bertrand, Saint Martial (FR)

(73) Assignee: CHOMARAT TEXTILES INDUSTRIES, Le Cheylard (FR)

(21) Appl. No.: 13/266,175

(22) PCT Filed: Apr. 27, 2010
(86) PCT No.: PCT/FR2010/050795

§ 371 Date: Oct. 25, 2011

(30) Foreign Application Priority Data
Apr. 27, 2009 (FR) 0952747

(51) Int. Cl. D06Q 1/00; B32B 37/06; B32B 3/10; B32B 38/10; B32B 38/14; B32B 37/02; B32B 37/10

(52) U.S. Cl. 428/196; 156/247; 156/248; 428/411.1; 428/335; 428/195.1

(57) ABSTRACT

A method for producing a textile complex including a textile web and an upper coating layer having an irregular surface condition, and including decorative patterns applied onto the upper coating layer. The method includes preparing a multi-layer decoration complex having at least a substrate layer, a coloured layer, and a heat-fusible layer, cutting the coloured and heat-fusible layers along outlines of the decorative patterns without cutting the substrate layer; removing portions of the coloured and heat-fusible layers outside the pattern areas; arranging the prepared multi-layer complex on the upper coating layer by way of the surface thereof with the heat-fusible layer; applying temperature and pressure conditions that trigger the adhesion of the heat-fusible layer to the upper coating layer; and then subjecting the assembly to a processing resulting in a structured and regular surface condition of the upper coating layer.

The present application is a National Stage Application of PCT International Application No. PCT/FR2010/050795 (filed on Apr. 27, 2010), under 35 U.S.C. §371, which claims priority to French Patent Application No. 0952747 (filed on Apr. 27, 2009), which are each hereby incorporated by reference in their respective entireties.

### FIELD OF THE INVENTION

The invention relates to technical textiles, and more specifically to coated textiles that include decorative patterns, or, more commonly, markings. It is most specifically implemented in respect of coated textiles for use in the fine leather goods, furnishings, clothing or motor industry.

### BACKGROUND OF THE INVENTION

In general terms, the coated textiles used in fine leather goods are employed as a substitute or replacement for natural materials such as leather or the like. The appearance of these materials is a particularly sensitive matter, and they therefore have to be of impeccable visual quality. Another much sought-after quality in respect of this type of material is good resistance to various mechanical constraints, and particularly to abrasion.

Hitherto, coated textiles have been known that includes a textile web covered with an upper coating layer, typically based on polyvinyl chloride, polyurethane, or thermoplastic polyolefins. For some uses, this coated textile is generally subjected to a processing step resulting in an irregular surface condition, so that the grain of leather can be replicated visually.

In a complementary way, and still for some uses, customizing or decorating the textile complex requires the printing of diverse decorative patterns in the general sense of the term. It may for example be a matter of marking various identification marks, logos or diverse patterns in picture or word form.

The techniques employed hitherto to implement this type of marking use silk-screen printing methods. To do this, according to a conventional technique, the coated textile receives a layer of ink which passes through the pores of a membrane stretched over a frame, and which is permeable in the areas where the patterns are to be drawn.

This silk-screen printing technique does, however, have a number of drawbacks when it is applied to decorating coated textiles with an irregular surface condition. Indeed, and in general terms, silk-screen printing operations are cumbersome, complex and expensive, in so far as they require the use of fixed frames, over which the partially porous membranes are stretched. They, therefore, require printing operations to be carried out on parts previously cut to the dimensions of the frames, which are then joined together for the finishing operations. The production processes impose discontinuous working, with the material for marking immobilised during an entire print cycle. Furthermore, as a function of the contrast between the marking colour and the colour of the upper coating layer of the textile, it may be necessary to print in a plurality of runs, in order to deposit a sufficiently large quantity of ink so that the background colour of the coating layer of the textile does not modify the way the ink layer is perceived. Multiplying these print steps is clearly detrimental to the cost of the overall marking operation.

Furthermore, and from a technical point of view, silk-screen printing gives results of highly debatable quality, and particularly when it is wished to make items that have a grainy or generally irregular surface condition. Indeed, the graining operation is more generally performed by passing the textile complex under an impression that has the inverted graining pattern, which is applied with temperature and pressure conditions so that it matches the upper coating layer of the complex. To work continuously, this operation is generally performed using a calender, one of the rolls of which has the required graining pattern, together with appropriate heating means. In fact, it is generally noted that the use of a certain temperature and pressure triggers colour modification phenomena in the markings obtained by silk-screen printing, or even also the appearance of bubbles that arise between the upper surface of the coating layer and the layer of silk-screen printing ink. These phenomena translate into an unfavourable visual appearance. Furthermore, the inks used for silk-screen printing have less abrasion resistance and flexural strength, which causes the decorated items to deteriorate over time.

### SUMMARY OF THE INVENTION

One of the objectives the invention sets out to achieve is the elimination of these drawbacks, so that patterns can be produced that combine good visual qualities with better mechanical performance, and abrasion resistance in particular, and to do so by enabling the production of highly varied form patterns, geometries and colours. Another objective is to simplify production process operations, with the aim of eliminating the cutting and/or joining operations, which render the current process discontinuous.

The invention relates therefore to a method for producing a textile complex conventionally comprising a textile web and an upper coating layer, and having an irregular, i.e. not perfectly plane, surface condition. This complex includes decorative patterns applied onto the upper coating layer.

In accordance with the invention, the method includes at least the following steps: preparing a multi-layer transfer complex, including a substrate layer, on which the cut decorative patterns lie, arranged in an orientation symmetrical to their future arrangement on the textile complex, each decorative pattern including at least one coloured layer, in contact with the substrate layer, and a heat-fusible layer, intended to come into contact with the upper coating layer.

In a subsequent step, this multi-layer complex thus prepared is arranged on the upper coating layer of the textile complex, by affixing the surface of the multi-layer complex with the heat-fusible layer to the coating layer. Then, in a subsequent step, temperature and pressure conditions are applied that trigger the adhesion of the heat-fusible layer to the upper coating layer of the textile complex. Then, after the substrate layer has been withdrawn or removed from the multi-layer decoration complex, a layer of varnish is deposited which coats the upper coating layer and the decorative patterns. Lastly to end with, the assembly is subjected to a processing resulting in a structured and irregular surface condition of the upper coating layer.

Put another way, the invention is directed to producing the patterns on a transfer agent including a substrate layer on which the various patterns are provided, in an inverted configuration. The exposed surface of this decoration complex is then applied to the coated textile, so that it can bond thereto under the effect of the heat and the pressure. Then, the substrate layer, which was acting as a support for the various patterns relative to each other, is removed by being stripped off to leave the possibility of performing various finishing operations, in particular by graining.

In this way, patterns are obtained that are particularly resistant, since they adhere very firmly to the coating layer covering the textile, and they are consequently able to undergo with better resistance the subsequent steps of embossing, graining or the like. The assembly therefore has better abrasion resistance, compared with the known techniques of marking by silk-screen printing.

In practice, it is possible to produce this transfer complex according to different operational modes, depending on the intended uses.

Thus, in a first scenario, the preparation of the transfer complex includes starting from a multi-layer complex that includes at least one substrate layer, coloured layer and heat-fusible layer, cutting the coloured layer and the heat-fusible layer solely along the outlines of the decorative patterns to be produced, and doing so without cutting the substrate layer. This preparation continues by removing the fractions of the coloured layer and the heat-fusible layer, located outside the pattern areas.

In another scenario, the preparation includes, starting from a complex that includes at least three basic layers, namely a holding layer, a heat-fusible layer and a printable decoration layer, in printing the printable decoration layer in order to form the coloured layer, and then cutting the coloured layer and the heat-fusible layer along the outlines of the decorative patterns, without cutting the holding layer. It is then possible to proceed in a plurality of ways, depending on the materials and intended uses. The fractions of the coloured layer and the heat-fusible layer outside the pattern areas can thus be removed, and the remaining areas of the coloured layer are then covered with the substrate layer, so as finally to remove the holding layer. A transfer complex is thus obtained that can be applied to the coated textile. It is also possible to perform these operations in the reverse order, by covering the entire printed layer in order then to remove the holding layer and the fractions of the coloured layer and the heat-fusible layer, outside the pattern areas.

Thus, in this second scenario, it is possible to deposit patterns that have a total variety of colours, by printing, upon request, an appropriate coloured layer, for example, by an ink jet method.

Advantageously, in practice, the heat-fusible layer can be bonded to the upper coating layer of the textile complex via a transfer step that includes exposure to a heat source, calendering, and then cooling.

Advantageously, the cooling may be carried out while the textile complex and the multi-layer complex are under pressure. This ensures in particular optimum adhesion, since when the cooling is carried out under constraints, it limits the creation of areas of debonding of the marking elements.

In practice, the choices of thicknesses and materials for the various layers allow diverse finishing and particularly graining steps to be carried out, which may be applied, manually or automatically. It is thus possible to subject the assembly to a processing resulting in a structured surface condition of the upper coating layer of the textile complex. The excess thickness effects due to the additions to the multi-layer complex are much reduced, or even cancelled during these finishing operations, by means of which the multi-layer complex is as if integrated into the upper surface of the coating layer of the coated textile.

In practice, it is also possible to use coated textiles which, prior to the inventive method, have been subjected to a print operation, which has conferred upon them an original visual appearance, onto which the decorative patterns implemented in accordance with the invention will be superimposed. The decorative patterns may thus be positioned in a chosen way relative to the original printing of the coated textile.

Thus, in relation to the complex produced in accordance with this method, it may be observed in terms of the decorative patterns, that it includes, on top of the textile coated layer, a first layer of heat-fusible polymer covered with a second layer based on a coloured polymer, possibly covered overall with a layer of varnish.

### BRIEF DESCRIPTION OF THE DRAWINGS

The way in which the invention may be implemented, together with the resulting advantages, will become clearer from the description of the following embodiments, supported by the appended drawings.

FIG. 1 is an outline perspective view of a sample of the multi-layer complex used to decorate a coated textile, shown after the pattern outlines have been cut out, and according to a first operating mode.

FIG. 2 is an outline perspective view of the multi-layer film in FIG. 1, shown after peeling away.

FIG. 3 is an outline perspective view of a sample of a complex used to produce a multi-layer complex according to a second operating mode, and shown after the pattern outlines are cut out.

FIG. 4 is an outline perspective view of the complex in FIG. 3, shown after the substrate layer has been put in place.

FIG. 5 is an outline perspective view of a sample of the multi-layer complex obtained from the complex in FIG. 4, shown at the moment of peeling away.

FIG. 6 is an outline perspective view showing the multi-layer complex in FIG. 2 or 5 put in place on a coated textile, before being exposed to the heat.

FIG. 7 is an outline diagrammatic perspective view of a facility on which the various operations of the inventive method are performed.

FIG. 8 is a partial diagrammatic cross-section view of a textile complex in accordance with the invention in terms of a decorative pattern.

Clearly, the dimensions and particularly the thicknesses of the various layers making up the various associated objects, whether it is the multi-layer decoration complex or the coated textile, are given solely by way of example. They may be quite different from the thicknesses observed in respect of real products, and have therefore been exaggerated so that the invention can be represented and understood.

### DETAILED DESCRIPTION OF EMBODIMENTS

As already disclosed, the invention relates to a method for decorating coated textiles, which uses a multi-layer complex for defining the patterns which are then transferred to the coated textile.

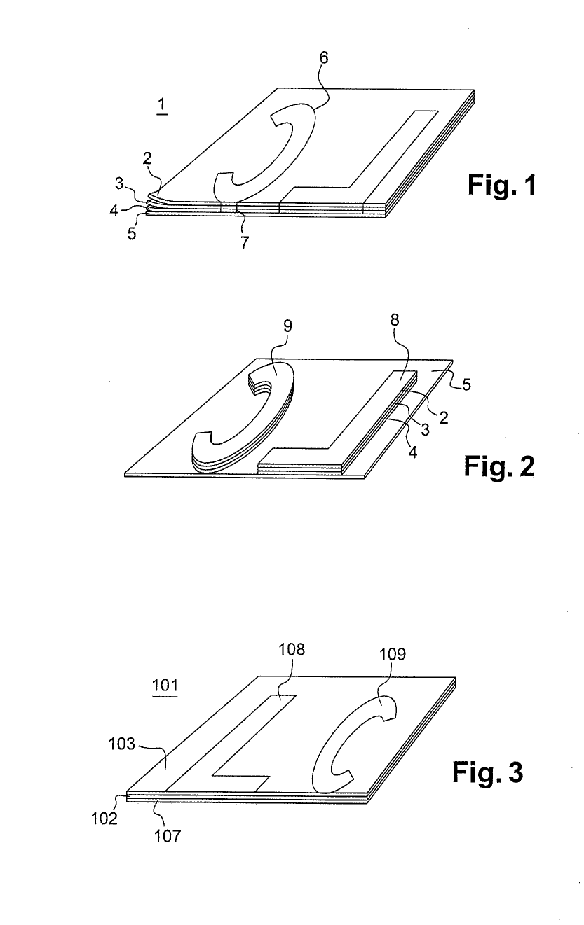

A multi-layer complex of this kind is shown in FIG. 1. This complex 1 includes a lower or first substrate layer 5, which may typically be made based on a polymer such as polyester, and more specifically polyethylene terephthalate (PET). This substrate layer 5 may thus to advantage be transparent and with its upper surface (i.e., the one facing towards the other layers in the complex) made adhesive. More specifically, this surface has received an adhesive such as an acrylic size which allows this substrate layer 5 to be bonded and then debonded repeatedly. In the case in point, making this surface adhesive means that the substrate layer 5 is strippable, i.e., can be separated from the other layers of the multi-layer complex 1. The other surface of the substrate layer 5 bears a non-stick treatment, so that it can be easily detached, as a result of which the multi-layer complex 1 is able to be rolled before use and then easily unrolled. Typically, this substrate layer 5 has a thickness of between 75 and 150 micrometres, and more specifically of about one hundred micrometres.

The multi-layer complex 1 also includes an intermediate coloured layer 4, which may typically be based on a coloured polyurethane film. In the form illustrated, this coloured layer 4 is associated with a second intermediate coloured layer 3 typically white or the like, which has opacifying power, such that the coloured layer 4 will not see its colouring disturbed by the background onto which the pattern will be transferred. Typically, the opacifying layer 3 has thicknesses of about a few tens of microns, and typically between 15 and 40 micrometres, and more specifically, close to 30 microns.

Above the coloured layers 3, 4, the multi-layer complex 1 includes an upper heat-fusible layer or film 2, of a thickness of about a few tens of microns, and typically between 20 and 60 micrometres, and preferentially, close to 30 microns. This heat-fusible layer 2 is made based on a polymer such as co-polyester or the like, for example, with a melting point close to 125° C. Other heat-fusible materials may be used depending on the chemical nature of the coating layer.

In a first step in the inventive method, this multi-layer complex 1 is prepared by cutting the outlines 6 of the patterns for transfer, taking into account that the heat-fusible layer 2 will then be affixed to the coated textile. The patterns must then be inverted at the time of cutting. Importantly, this cutting must be performed solely on the layers which will be transferred, i.e. on the heat-fusible layer 2 and the coloured layer or layers 3,4. It is vital that the substrate layer 5 is not cut, or at least only partially, so as to retain its substrate function and ensure the positioning of the various patterns relative to each other. The cutting is therefore performed by means of conventional tools so that the depth of cut can be calibrated.

As illustrated in FIG. 2, in a subsequent step, portions of the heat-fusible layer 2 and the coloured layer or layers 3,4 are then removed outside those areas that will form the patterns 8, 9. This so-called “peeling away” operation allows only the various patterns 8, 9 for transfer to be retained on the substrate sheet 5. This peeling away is possible by virtue of the controlled adhesive power of the upper surface of the substrate layer 5.

As illustrated in FIG. 3, an alternative technique can be used to produce a similar result, and starting with a complex 101. Such a complex 101 includes an upper printable decoration layer 103, which is, for example, based on powder-filled polyurethane resin facilitating ink retention, when printing is carried out using “ink jet” technologies. This layer 103 has capacities for receiving a decoration by means of diverse printing operations, and particularly, from a printing of the “ink-jet” type. This decoration layer lies on an intermediate heat-fusible layer 102 similar to the heat-fusible layer mentioned earlier and illustrated in FIGS. 1 and 2. This heat-fusible layer 102 itself lies on a lower holding layer 107, which is typically based on polyester, of a thickness of about a hundred microns. In so far as the heat-fusible layer 102 has intrinsic adhesion capacities, it can be combined with the holding layer without difficulties. The main function of the holding layer 107 is to allow the assembly to be handled during printing operations, which allow as illustrated in FIG. 3 and by way of example, the patterns 108, 109 to be produced.

In a subsequent step, the outlines of the patterns are cut from the printed surface, taking care to cut only the printable decorative layer 103 and the heat-fusible layer 102, and without cutting the holding layer 107, at least not in a proportion that might cause it to tear when it is stripped off.

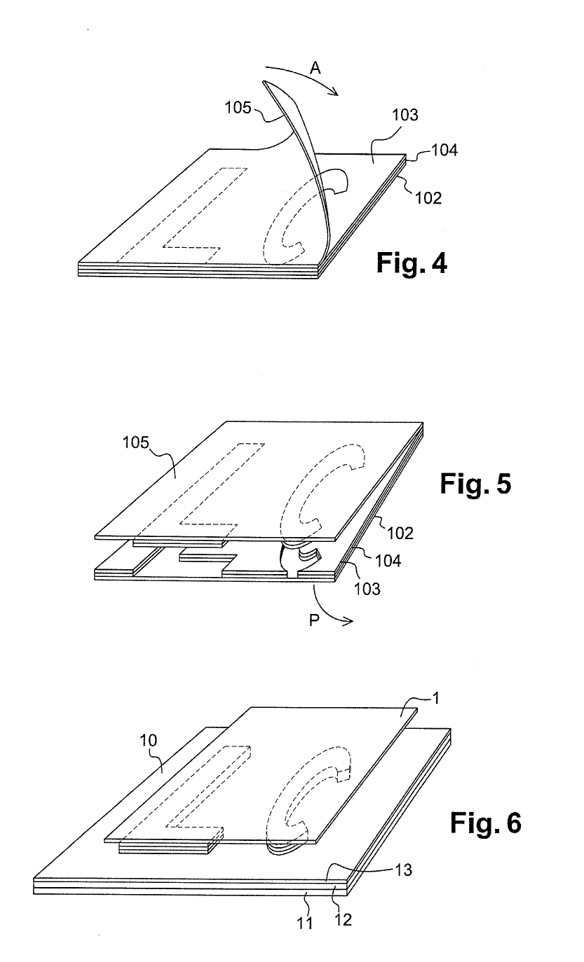

As illustrated in FIG. 4, in a subsequent step, the assembly is covered in the direction of arrow A with a substrate layer 105, similar to the substrate layer 5 described above and illustrated in FIGS. 1 and 2.

As illustrated in FIG. 5, next, the holding layer 102 is taken away by being stripped off in the direction of arrow P. In this way, the portions of the heat-fusible layer 104 and of the printable decorative layer 103 which are external to the patterns are also removed, by being peeled away as mentioned earlier.

Clearly, and in an alternative not illustrated, it is also possible to peel away directly after cutting the outlines of the patterns, and to do so before the substrate layer is put in place. In this case, the latter is put in place subsequently, and lies directly on the top of the cut patterns. The holding layer alone should then be removed.

As illustrated in FIG. 6, it is thus possible next, to arrange the multi-layer complex 1 thus prepared on the areas where it is wished to transfer onto the coated textile 10. More specifically, this coated textile 10 as illustrated in FIG. 6, has firstly a lower textile web 11 which can be produced in various ways, by a cloth, a knitted fabric or again a non-woven fabric. Various associations or combinations are conceivable furthermore without departing from the context of the invention. The upper surface of this textile web 11 is covered with one or more intermediate coating layers 12. This coating layer 12 may typically be based on polyvinyl chloride (PVC), polyurethane (PU), or thermoplastic polyolefins (TPO), or again on various stacked coating layers, depending on the intended use.

In one particular embodiment that gives satisfaction in terms of graining stability, using textiles with the coating layer thereof being based on polyvinyl chloride, a coloured polyurethane-based layer is employed, with a Young's modulus at 100% elongation of between 50 and 100 kg/cm², and typically close to 63 kg/cm², and a hardness of between 60 Shore A and 40 Shore D, typically close to 85 Shore A. Complementarily, the graining stability is improved when the heat-fusible layer is chemically compatible with the material constituting the coloured layer. This is the case, for example, when employing a heat-fusible layer based on co-polyester, and combined with a coloured polyester-based polyurethane layer.

It is also possible, as illustrated in FIG. 6, for this coating layer 12 to have been subjected to a prior printing step by the deposition of an upper decoration layer 13 specific to the coated textile. This printing may be total or partial, and define, for example, other patterns specific to the coated textile. Various decoration or printing techniques may therefore be used, such as in particular gravure printing.

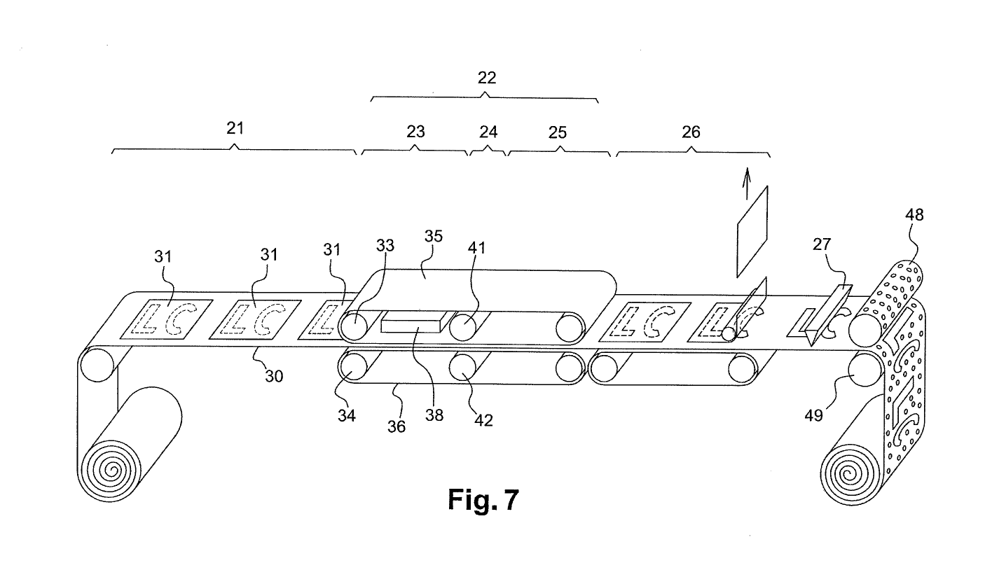

As illustrated in FIG. 7, the inventive method, therefore, includes firstly in arranging the multi-layer decoration complexes 31 with the cut patterns, at a first station 21, opposite the upper coating layer of the coated textile 30. This multi-layer complex may be deposited either by means of distinct elements separated from each other, as illustrated in FIG. 7, or else by continuously running a continuous substrate layer carrying a plurality of successive patterns.

The coated textile covered with the multi-layer complex next moves into a second station 22 known as a “transfer station.” In the first part 23 of this station, the coated textile 30/multi-layer complex 31 assembly passes between two belts 35, 36, after passing through an area including two rolls 33, 34 placed opposite one another so that pressure can be applied on the two elements 30, 31 for assembly. In this first area 23, heating means 38 are provided in the upper belt circuit 35, so as to heat the multi-layer complex 31, and in particular its heat-fusible layer. The temperature prevailing in this area, on the upper coated textile surface, may depend on the chemical nature of the heat-fusible film. A temperature of between 120 and 180° C., and close to 150°, may bring good results with the co-polyesters described above in composition of the heat-fusible layer. To avoid deterioration of the coated textile and in particular of its coating layer, the temperature may be maintained at much lower levels in the lower belt 36. Maintaining an ambient temperature means that deterioration of the coated textile can be avoided.

Upon leaving the first part 23 of the transfer station, the coated textile multi-layer film assembly passes between two rolls 41, 42 of a calender 24, so that pressure can be applied that promotes intimate hot contact between the heat-fusible layer and the upper surface of the coating layer of the coated textile 30. This pressure may typically be between a few Newtons and a few tens of Newtons approximately per square centimetre. The gap between the belts 35, 36 at the calender 24 may be set very slightly below the thickness of the coated textile, it being understood that said thickness is much greater than the thickness of the multi-layer decoration complex, unlike what may be seen in the figures which, it will be remembered, are given by way of example.

After the transit between the calendering rolls 41, 42, the facility includes a cooling area 25, in which the temperature is maintained at a low level, typically at ambient temperature, underneath but also on top of the coated textile. This cooling is carried out under constraint, i.e., pressure is maintained between the two belts 35, 36 such that the heat-fusible layer, but also the coloured layer and the coating layer of the coated textile, cool down while remaining in contact with each other, and do so in order to avoid the creation of debonding areas, or the appearance of bubbles.

At the output from the transfer station 22, the machine 20 includes a stripping station 26, in which the substrate layer 5 of the multi-layer film is removed, using manual or automated means.

Subsequently, at a station 27, the coated textile receives a deposition of a layer of varnish in order in particular to protect against external mechanical and/or chemical stresses and also to achieve the required lustre.

The coated textile may then be subjected to various finishing operations, and particularly, as illustrated in FIG. 7, a graining or hot embossing operation. To do this and conventionally, the textile passes between two rolls 48, 49, and its coated surface is brought into contact with a roll 48 that has a surface condition complementary to the surface condition required for the finished product. Complementary finishes are also possible before and/or after the hot embossing operation. It is thus possible to implement complementary printing, preferably before the embossing, and the deposition of the layer of varnish.

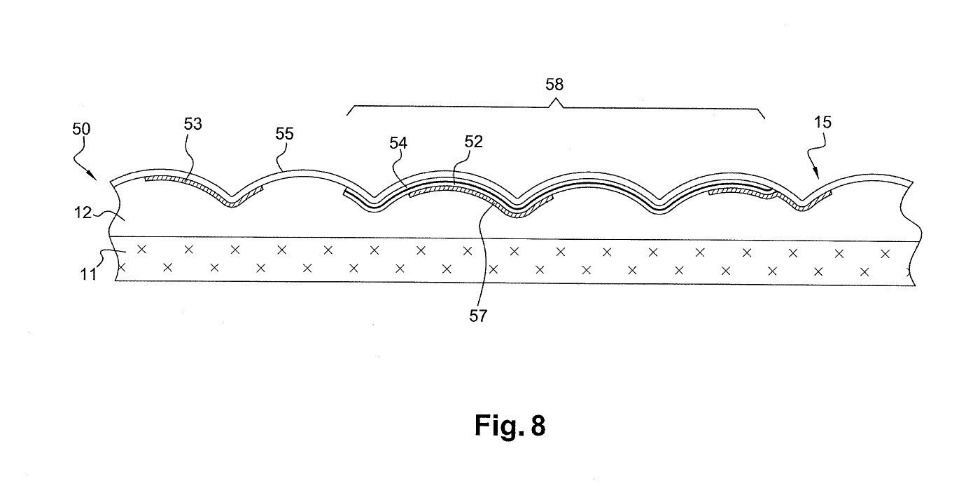

As illustrated in FIG. 8, thus, the coated textile 50 includes a textile web 11 covered with the upper coating layer 12 which has an irregular, i.e., non planar, upper surface 15. The upper surface 15 of the coating layer 12 has at different points thereof patterns 53, 57 printed by operations prior to the inventive method. In the specific areas 58 of the characteristic patterns, the coloured layer 54 and the heat-fusible layer 52 of the multi-layer complex lies partially on some pre-printed patterns 57. An additional layer 55 of varnish covers the entire surface of the coating layer, including on the pre-printed patterns or on the patterns transferred in accordance with the invention.

It is clear from what has been said that the inventive method has the advantage of allowing marking which has better abrasion resistance and a better quality of finish relative to the grained coated textile known hitherto, and with a more cost-effective method.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1-14. (canceled)

15. A method for producing a textile complex including a textile web and an upper coating layer, and decorative patterns applied onto the upper coating layer, the method comprising:
preparing a multi-layer transfer complex comprising a first layer, on which cut the decorative patterns lie, arranged in an orientation symmetrical to their future arrangement on the textile complex, each decorative pattern including at least one second layer in contact with the first layer, and a third layer configured for contact with the upper coating layer;
arranging said prepared multi-layer transfer complex on the upper coating layer by way of the surface thereof with the third layer;
applying temperature and pressure conditions that trigger an adhesion of the third layer to the upper coating layer;
removing the first layer;
depositing a layer of varnish covering the upper coating layer and the decorative patterns; and then
subjecting the textile complex to a processing resulting in a structured and irregular surface condition of the upper coating layer.

16. The method of claim 15, wherein:
the first layer comprises a substrate layer;
the second layer comprises a coloured layer; and
the third layer comprises a heat-fusible layer.

17. The method of claim 16, wherein preparing the multi-layer transfer complex comprises:
cutting the coloured layer and the heat-fusible layer along outlines of the decorative patterns without cutting the substrate layer; and then
removing portions of the coloured layer and the heat-fusible layer in areas outside of the decorative patterns.

18. The method of claim 15, wherein:
the first layer comprises a holding layer;
the second layer comprises a heat-fusible layer; and
the third layer comprises a printable decoration layer.

19. The method of claim 18, wherein preparing the multi-layer transfer complex comprises:
printing the printable decoration layer to form a coloured layer;
cutting the coloured layer and the heat-fusible layer along outlines of the decorative patterns without cutting the holding layer;
covering the coloured layer with a substrate layer; and then
removing the holding layer and portions of the coloured layer and the heat-fusible layer in areas outside of the decorative patterns.

20. The method of claim 18, wherein preparing the multi-layer transfer complex comprises:
printing the printable decoration layer to form a coloured layer;
cutting the coloured layer and the heat-fusible layer along outlines of the decorative patterns without cutting the holding layer;
removing portions of the coloured layer and the heat-fusible layer in areas outside of the decorative patterns;
covering the coloured layer with a substrate layer; and then
removing the holding layer.

21. The method of claim 15, wherein the third layer is bonded to the upper coating layer via a transfer step that includes:
exposure to a heat source;
calendering; and then
cooling.

22. The method of claim 21, wherein the cooling is carried out while the textile complex and the multi-layer complex are under pressure.

23. The method of claim 15, further comprising:
printing the textile complex prior to arranging the multi-layer decoration complex.

24. A textile complex comprising:
a lower layer;
an upper layer having an irregular surface condition; and
decorative patterns applied onto the upper layer, wherein each one of the decorative patterns includes a first decorative pattern layer comprising a heat-fusible polymer provided on top of the upper layer, and a second decorative pattern layer comprising a coloured polymer provided on the first decorative pattern layer.

25. The textile complex of claim 24, wherein:
the lower layer comprises a textile web; and
the upper layer comprises a coating layer.

26. The textile complex of claim 25, further comprising:
a layer of varnish provided on and covering the coating layer and the decorative patterns.

27. The textile complex of claim 26, wherein the coating layer has a print layer.

28. The textile complex of claim 27, wherein the coloured polymer lies on an opacifying layer.

29. The textile complex of claim 28, wherein the opacifying layer has a thicknesses of between 15 and 40 micrometres.

30. A multi-layer decoration complex comprising:
a lower layer;
an intermediate layer in contact with the lower layer; and
an upper layer in contact with the intermediate layer.

31. The multi-layer decoration complex of claim 30, wherein:
the lower layer comprises a substrate layer;
the intermediate layer comprises a coloured layer; and
the upper layer comprises a heat-fusible layer.

32. The multi-layer decoration complex of claim 31, further comprising an opacifying layer interposed between the coloured layer and the heat-fusible layer.

33. The multi-layer decoration complex of claim 32, wherein the opacifying layer has a thicknesses of between 15 and 40 micrometres.

34. The multi-layer decoration complex of claim 30, wherein:
the lower layer comprises a holding layer;
the intermediate layer comprises a heat-fusible layer; and
the upper layer comprises a decoration layer configured to have decorative printing patterns.
